(19) United States
(12) Patent Application Publication
(10) Pub. No.: US 2007/0165530 A1
(43) Pub. Date: Jul. 19, 2007

(54) Method, System And Device Of Traffic Management In A Multi-Protocol Label Switching Network

(75) Inventor: Weisi Dong, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 11/620,278

(22) Filed: Jan. 5, 2007

(30) Foreign Application Priority Data
Jan. 18, 2006 (CN) 200610001621.7.

(51) Int. Cl. H04J 1/16; H04L 12/56

(52) U.S. Cl. 370/235; 370/389; 370/400

(57) ABSTRACT

Embodiments of the invention provide a method of traffic management in a Multi-Protocol Switching (MPLS) network. The method includes: setting a management tag on the outer layer of service traffic data carried in an MPLS packet when the MPLS packet is sent initially; and upon receiving the MPLS packet, identifying the service traffic data carried in the MPLS packet according to the management tag set in the MPLS packet, and performing traffic management. Systems and MPLS network devices are also disclosed in embodiments of the present invention. Through the embodiments of the present invention, traffic management in an MPLS network can be implemented.

### CROSS-REFERENCE TO RELATED APPLICATIONS

This application claims the benefit of Chinese Patent Application No. 200610001621.7 filed on Jan. 18, 2006. The disclosure of the above application is incorporated herein by reference.

### FIELD

The present disclosure relates to the network communication technology, and more particularly, to a method, a system and a device of traffic management in a Multi-Protocol Label Switching (MPLS) network.

### BACKGROUND

The statements in this section merely provide background information related to the present disclosure and may not constitute prior art.

The MPLS technology has already been widely used in Internet Protocol (IP) bearer networks; hence the new generation IP bearer network is also called an MPLS bearer network. The IP bearer network implements multi-service isolation, QoS guarantee and the traffic engineering of the IP network by using MPLS-related technologies, such as, an MPLS Virtual Private Network (MPLS VPN), MPLS Traffic Engineering (MPLS TE), and etc. Therefore, in the current IP bearer network, the majority of traffics are the MPLS label traffics, which are based on either a Point-to-Point (P2P) MPLS tunnel or a Point-to-Multi-Points (P2MP) MPLS tunnel.

In a pure IP traffic network, by obtaining quintuple of an IP packet, the meaning of the network traffics may be known completely, and the traffic control, e.g., QoS re-tagging, security control, traffic regulation, and etc., may be implemented. However, in an MPLS label switching network, the network traffic management can not be performed as that done in the pure IP traffic network, since the traffics in the MPLS network are MPLS labels, and the labels are assigned dynamically, the special meanings of which can not be determined in advance. Especially, in an MPLS VPN, multilayer labels are usually adopted, and the meaning indicated by the label of each layer can not be determined inside the network; furthermore, it is unfeasible to shuck these network labels to identify the internal information, because the MPLS packets therein may be IP packets where the case of address overlap may exist, or may be certain link-layer packets or Time Division Multiplex (TDM) information which can not be identified inside the network.

Thus, the traffic analysis functions of some current routers are unable to analyze and manage the MPLS network traffic actually. In addition, the traditional IP address-based management method of network traffics is substantially implemented based on special hosts (i.e., quintuple based on an IP address) and can not incarnate the management on a domain, a convergence service class, or a user group, because the IP address information of these individuals being managed is disorderly distributed . In other words, it is inefficient and inconvenient to manage the network traffic merely depending on the IP address information.

### SUMMARY

Embodiments of the present invention provide a method of traffic management in an MPLS network, including:

setting a management tag on the outer layer of service traffic data carried in an MPLS packet when the MPLS packet is sent initially; and

after receiving the MPLS packet, identifying the service traffic data carried in the MPLS packet according to the management tag set in the MPLS packet, and performing traffic management for the service traffic data.

An embodiment of the present invention provides a system of traffic management in an MPLS network, including:

a management tag configuration module, configured for setting a management tag on the outer layer of service traffic data carried in an MPLS packet;

a traffic identification module, configured for identifying the service traffic data carried in the MPLS packet according to the management tag set in the MPLS packet, and sending an identification result to a traffic management module; and

the traffic management module, configured for receiving the identification result from the traffic identification module and performing traffic management.

An embodiment of the present invention also provides an MPLS network device, including:

a management tag configuration module, configured for setting a management tag on the outer layer of service traffic data carried in an MPLS packet, and sending out the MPLS packet.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagram illustrating the modules in an embodiment of the system according to an embodiment of the present invention;

FIG. 2 is a diagram illustrating the management tag assignment of the system according to an embodiment of the present invention; and

FIG. 3 is a flowchart of an embodiment of the method according to an embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Embodiments of the invention provide a method, a system and a device of traffic management in an MPLS network, wherein, a management tag is set in an MPLS packet at the edge of the MPLS network, more particularly, the tag is set between the user traffic data and the MPLS service label so that the service traffics can be identified, by which means the management of the MPLS service traffic can be made more conveniently.

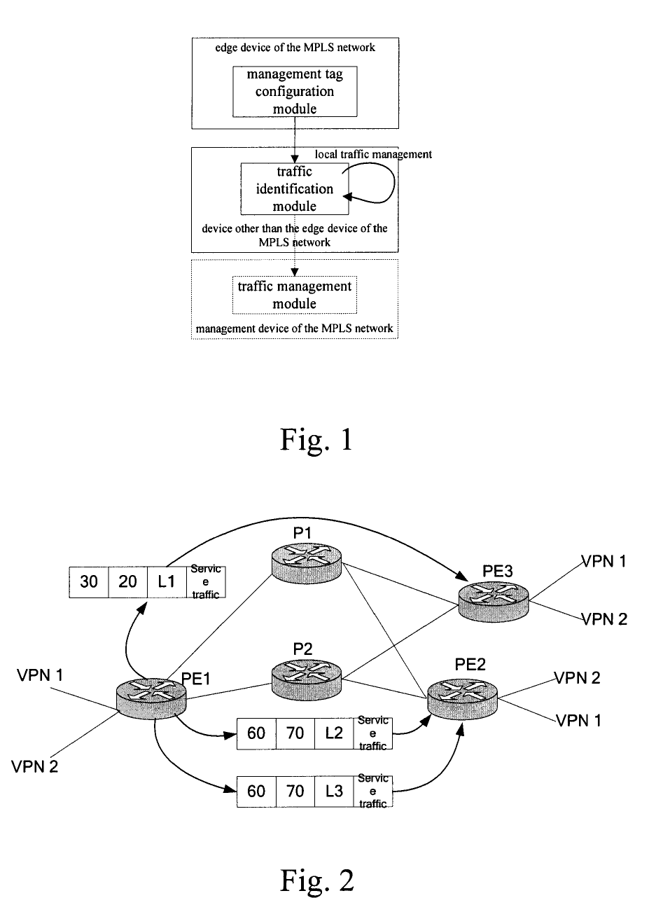

An embodiment of a system of traffic management in an MPLS network is shown in FIG. 1. The system includes a management tag configuration module, a traffic identification module and a traffic management module.

The management tag configuration module can be integrated into an edge device of the MLPS network, it is used to set a management tag between the user traffic data and the MPLS service label in an MPLS packet, wherein, different management tags represent different traffic meanings. The management tag configuration module may assign a management tag for a service to be managed by the network according to the management demands. For example, if service traffics, sent to different Provider Edges (PE) by a VPN, need precise management, different management tags may be assigned to the service traffics sent to the different PEs respectively; if it is unnecessary to consider the difference of the service traffics sent by the VPN to the different PEs, only one management tag can be assigned to the service traffics sent by the VPN; and if it is desired to know the traffics which is in a certain VPN and is from a certain PE site, one management tag may be independently assigned to the service traffics accessed by the PE site. As shown in FIG. 2, L1 may be used as a management tag of service traffics from PE1 to PE3 in the VPN1 service, L2 may be used as a management tag of service traffics from PE1 to PE2 in the VPN1 service, and L3 may be used as a management tag of the service traffics in the VPN2 service without distinguishing the destination addresses of the service traffics.

The traffic identification module is integrated into a device other than the edge device on which the management tag configuration module is set, such as, a core device of the MPLS network, for identifying the special service traffic according to the management tag in the MPLS label packet from the management tag configuration module and sending the identification result to the traffic management module.

The traffic management module is integrated into a management device of the MPLS network, the traffic management module is used to obtain the identification result from the traffic identification module; and the traffic management module performs the corresponding management, including security management, QoS management, traffic distribution regulation, and charging etc., on the special service traffic according to the identification result.

The traffic identification module may be integrated into any other device of the MPLS network besides the core device of MPLS network mentioned above. Furthermore, the traffic management module may be integrated into the same device where the traffic identification module is integrated. In the case of the traffic management module and traffic identification module being integrated into the same device, After identifying the management tag, the traffic identification module transmits the identification result to the local traffic management module, thereby the network device, where the traffic identification module is located, is able to directly perform the local traffic management, e.g., QoS management, traffic statistic, and etc. If the traffic management module is integrated into a management device of the MPLS network, the traffic identification module transmits the traffic identified by the management tag to the traffic management module set on the management device which will perform the traffic management independently, such as, security analysis, charging, and etc.

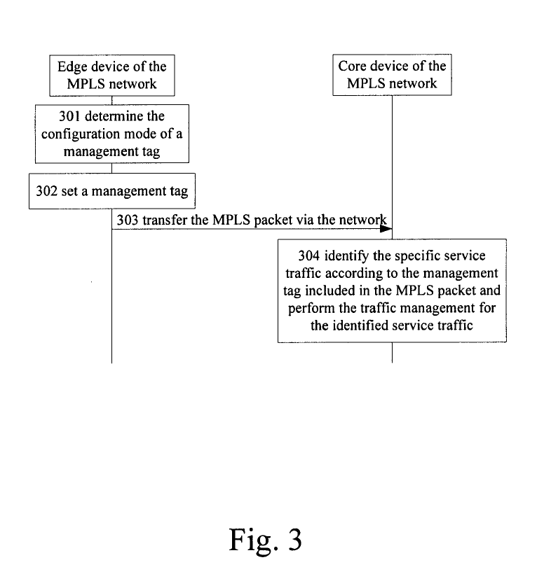

The procedure of the traffic management in an MPLS network according to an embodiment of the present invention is shown in FIG. 3. As shown in FIG. 3, in the embodiment, the procedure is applied to an edge device and a core device in the MPLS network, including:

Step 301: The management tag configuration module in the edge device of the MPLS network decides a configuration mode of the management tag.

The configuration mode of the management tag may be decided mainly according to the user management requirements, the mode may indicate that different management tags should be assigned respectively to the service traffics sent to different PEs by the VPN, or one management tag should be assigned to the service traffics sent to various PEs by the VPN, or one management tag should be assigned to the service traffics accessed by a certain PE site.

When different configuration modes of the management tag are adopted to set management tags, the management tags may represent different meanings, e.g., the traffic of a certain user's VPN, or the traffic between a pair of P2P sites in a certain VPN, or the traffic in a VPN which is submitted from a certain Customer Edge (CE) site, or the traffic of a certain service in a VPN, or the traffic submitted from a certain physical topology site in the transfer of a general public MPLS network, or the traffic of a P2MP MPLS multicast group etc. The management tag may be set as 4 bits long or with another length as required.

Step 302: After determining the configuration modes of the management tag, the management tag configuration module sets a management tag for the MPLS label packet currently to be sent.

The management tag may be set on the MPLS label packet in an edge device of an operator's MPLS network, or may be reset by an intermediate device inside the network. The management tag is independent of the user service and does not represent a special service meaning, but it is a kind of network management resources effective in the whole MPLS network of the operator. When in use, the management tag may be assigned based on a certain rule, such as, assigned by domain, service, or etc.

The management tag may be set on the outer layer of the user traffic data by the management tag configuration module according to the service management demands, and then other MPLS label information required by other service forward procedures may be set on the outer layer of the management tag. That is, the management tag is set below the MPLS label stack bottom and on the layer of the user traffic data, and as shown in the table below, it is set between the user traffic data and the MPLS service label:

| | | | |
|---|---|---|---|
| MPLS service | MPLS service label | management tag | user traffic |
| label | (stack bottom) | | data |

The management tag may be set according to a routing policy, e.g., the next hop of the route or a VPN tag; or it may be set according to the attributes of the route, e.g., the attributes of a group and an extended group of the Border Gateway Protocol (BGP); or it may be set according to a policy route, such as, an entry, a destination address, or a source address.

Step 303: The MPLS label packet configured with the management tag is transmitted in the MPLS network, via which the MPLS label packet is transmitted from the edge device of the MPLS network to the core device of the MPLS network.

Step 304: The traffic identification module in the core device of the MPLS network identifies the specific service traffic according to the management tag included in the MPLS label packet. The traffic identification module may send the identification result to the traffic management module located in an external network management device, which then performs the MPLS traffic management of the specific service traffic, e.g., charging and security analysis etc. On the other hand, the identification result may be also sent to the local traffic management module which performs the management of the local identified traffic directly, e.g., QoS management, traffic statistic, or traffic leading.

In terms of the traffic of one type of services, the management tag is unique and global effective in the MPLS network, so the operator can identify the traffic with this management tag in any device of the MPLS network as required, thus the path that the service traffic passes is clear to the operator, which provides a basis for further network management.

According to the management tag, the traffic identification module may identify the specific information of the service traffic, such as, the traffic of a certain user or the traffic of a certain service of a certain user. With regard to a multi-service bearer network, the service traffic may be identified as the traffic of the Next Generation Network (NGN), the traffic of the IP Television (IPTV), or the traffic of the Internet.

Based on the identified management tag, on the one hand, what can be known is the path that the user service traffic passes in the network and whether the path accords with the desired service plan. On the other hand, traffic statistic and charging can be performed, while, according to the management tag, management operations, such as, QoS re-tagging, security management, and traffic distribution regulation etc can be implemented on the service traffic in some nodes.

To sum up, the traffic management of an MPLS label switching network can be implemented in accordance with embodiments of the present invention, wherein, according to the desires of the user, the management method and management tags can be dynamically assigned to a management group to realize the network service's traffic distribution analysis, QoS management, charging management, and security management etc.

It is can be seen that the traffic management in an MPLS network can be realized by the embodiments of the present invention, where the network manager can identify traffic of a certain user as required and further perform for the traffic, analysis, statistic and charging, traffic engineering regulation, or QoS tagging etc.

The forgoing are only preferred embodiments of the present invention and are not intended to limit the protection scope of the present invention, and it should be known by those skilled in the art that there can be many deviations and changes within the range of the essential of the present invention, and the protection scope of which is defined in the following claims.

What is claimed is:

1. A method of traffic management in a Multi-Protocol Label Switching (MPLS) network, comprising:
setting a management tag on the outer layer of service traffic data carried in an MPLS packet when the MPLS packet is sent initially; and
after receiving the MPLS packet, identifying the service traffic data carried in the MPLS packet according to the management tag set in the MPLS packet, and performing traffic management for the service traffic data.

2. The method according to claim 1, further comprising: deciding a configuration mode of the management tag according to management demands, wherein, setting a management tag comprises:
setting the management tag based on the decided configuration mode of the management tag.

3. The method according to claim 2, wherein the decided configuration mode of the management tag comprises:
assigning different management tags to service traffics sent to different Provider Edges in a Virtual Private Network; or assigning one management tag to the service traffics sent to various PEs in a VPN; or independently assigning a management tag to the traffics accessed by a certain PE site.

4. The method according to claim 1, wherein setting a management tag comprises:
setting the management tag according to a routing policy, or attributes of the route, or a policy route.

5. The method according to claim 4, wherein setting the management tag according to a routing policy comprises:
setting the management tag according to the next hop of the route or a VPN tag.

6. The method according to claim 4, wherein setting the management tag according to attributes of the route comprises:
setting the management tag according to the attributes of a group or an extended group.

7. The method according to claim 4, wherein setting the management tag according to a policy route comprises:
setting the management tag according to an entry, a destination address, or a source address.

8. The method according to claim 1, wherein setting the management tag comprises:
setting, by an edge device of the MPLS network, the management tag when the edge device initiates the MPLS packet.

9. The method according to claim 1, wherein, identifying the service traffic data carried in the MPLS packet according to the management tag set in the MPLS packet and performing traffic management for the service traffic data comprises:
identifying, by a device of the MPLS network receiving the MPLS packet, the service traffic data and performing the traffic management; or,
identifying, by a device of the MPLS network receiving the MPLS packet, the service traffic data, sending, by the device of the MPLS network, an identification result to an external network management device, and performing, by the external network management device, the traffic management according to the identification result.

10. The method according to claim 1, wherein, the management tag set is global effective in the MPLS network.

11. A system of traffic management in an MPLS network, comprising:
a management tag configuration module, configured for setting a management tag on the outer layer of service traffic data carried in an MPLS packet;
a traffic identification module, configured for identifying the service traffic data carried in the MPLS packet according to the management tag set in the MPLS packet, and sending an identification result to a traffic management module; and
the traffic management module, configured for receiving the identification result from the traffic identification module and performing traffic management.

12. The system according to claim 11, wherein the management tag configuration module is further configured to decide a configuration mode of the management tag according to management demands and set the management tag according to the decided configuration mode of the management tag.

13. A system of traffic management in an MPLS network, comprising:
a first device, configured for initiating an MPLS packet and setting a management tag on the outer layer of service traffic data carried in the MPLS packet; and
a second device, configured for receiving the MPLS packet from the first device, and identifying the service traffic data carried in the MPLS packet according to the management tag set in the MPLS packet.

14. The system according to claim 13, wherein,
the second device is further configured for performing traffic management for the identified service traffic data.

15. The system according to claim 13, wherein, the system further comprises:
a third device, configured for receiving an identification result of the service traffic data from the second device, and performing traffic management according to the identification result.

16. A system of traffic management in an MPLS network, comprising:
an edge device of the MPLS network, configured for initiating an MPLS packet and setting a management tag on the outer layer of service traffic data carried in the MPLS packet; and
a core device of the MPLS network, configured for receiving the MPLS packet from the edge device of the MPLS network, and identifying the service traffic data carried in the MPLS packet according to the management tag set in the MPLS packet.

17. The system according to claim 16, wherein,
the core device of the MPLS network is further configured for performing traffic management for the identified service traffic data.

18. The system according to claim 16, wherein, the system further comprises:
a management device of the MPLS network, configured for receiving an identification result of the service traffic data from the core device of the MPLS network, and performing traffic management according to the identification result.

19. An MPLS network device, comprising:
a management tag configuration module, configured for setting a management tag on the outer layer of service traffic data carried in an MPLS packet, and sending out the MPLS packet.

20. The device according to claim 19, wherein the management tag configuration module is further configured to decide a configuration mode of the management tag according to management demands and set the management tag according to the decided configuration mode of the management tag.

21. An edge device of an MPLS network, for initiating an MPLS packet, wherein, the device comprises:
a management tag configuration module, configured for setting a management tag on the outer layer of service traffic data carried in an MPLS packet, and sending out the MPLS packet.

22. The device according to claim 21, wherein, the management tag configuration module is further configured to decide a configuration mode of the management tag according to management demands and set the management tag according to the decided configuration mode of the management tag.

23. An MPLS network device, comprising:
a traffic identification module, configured for receiving an MPLS packet and identifying service traffic data carried in the MPLS packet according to a management tag in the MPLS packet.

24. The device according to claim 23, further comprising:
a traffic management module, configured for receiving an identification result of the service traffic data from the traffic identification module and performing traffic management.

25. A core device of an MPLS network device, comprising:
a traffic identification module, configured for receiving an MPLS packet and identifying service traffic data carried in the MPLS packet according to a management tag in the MPLS packet.

26. The device according to claim 25, further comprising:
a traffic management module, configured for receiving an identification result of the service traffic data from the traffic identification module and performing traffic management.
